(19) United States
(12) Patent Application Publication
(10) Pub. No.: US 2011/0258260 A1
(43) Pub. Date: Oct. 20, 2011

(54) Method of delivering traffic status updates via a social networking service

(76) Inventor: Tom Isaacson, Auckland (NZ)

(21) Appl. No.: 12/759,709

(22) Filed: Apr. 14, 2010

(51) Int. Cl. H04W 4/14; G06F 15/16

(52) U.S. Cl. 709/206; 455/466

(57) ABSTRACT

A method of receiving traffic status updates from a social networking service includes a communication device subscribing to a feed of a traffic monitoring service on a social networking service and requesting the social networking service to send short messages to the communication device when new traffic data is submitted to the social networking service by the traffic monitoring service. The method also includes the communication device receiving a short message containing traffic data from the social networking service in response to the traffic monitoring service submitting traffic data to the social networking service, parsing the short message with the communication device and extracting the traffic data contained in the short message, and processing the traffic data with a routing module of the communication device.

### BACKGROUND OF THE INVENTION

1. Field of the Invention

The invention relates to a method of delivering traffic status updates, and more particularly, to a method of delivering traffic status updates to communication devices via a social networking service.

2. Description of the Prior Art

With the increasing popularity and increasing processing power of portable electronic devices, recently more and more devices have started to provide navigation assistance functions. Devices such as dedicated portable navigation devices and other more general portable electronic devices such as mobile phones are currently used to provide users with data regarding the user's current position as well as providing the user with navigation instructions to a destination. In addition to presenting maps to the users, some devices also provide real-time traffic status updates to the user, for enabling the user to have the most up-to-date information regarding the user's route.

Conventionally, traffic data can only be received via one of two methods. First, traffic data can be received over the radio. This requires a specialized radio receiver that is capable of deciphering data conforming to a specific standard. For example, for FM radio broadcasting, traffic data is often sent on the Traffic Message Channel (TMC) using the Radio Data System (RDS) protocol. Second, traffic data can also be received over the internet. However, in many places the cost of wirelessly accessing the internet over a mobile phone is still very expensive. Moreover, high speed networks able to connect at high speeds, such as 3G networks, still do not provide full coverage for most areas.

Many people are already owners of mobile phones that they take with them while driving or traveling. However, in order to receive traffic status updates over a mobile phone, the mobile phone currently requires a radio device capable of receiving TMC data through FM or satellite radio, or requires an expensive internet connection for receiving traffic updates via the internet. Unfortunately, neither of these options is currently affordable or suitable enough for widespread adoption.

### SUMMARY OF THE INVENTION

It is therefore one of the primary objectives of the claimed invention to provide a method and related communication device for receiving traffic status updates from a social networking service.

According to an exemplary embodiment of the claimed invention, a method of receiving traffic status updates from a social networking service is disclosed. The method includes a communication device subscribing to a feed of a traffic monitoring service on a social networking service and requesting the social networking service to send short messages to the communication device when new traffic data is submitted to the social networking service by the traffic monitoring service. The method also includes the communication device receiving a short message containing traffic data from the social networking service in response to the traffic monitoring service submitting traffic data to the social networking service, parsing the short message with the communication device and extracting the traffic data contained in the short message, and processing the traffic data with a routing module of the communication device.

According to another exemplary embodiment of the claimed invention, a communication device for receiving traffic status updates from a social networking service is disclosed. The communication device subscribes to a feed of a traffic monitoring service on the social networking service and requests the social networking service to send short messages to the communication device when new traffic data is submitted to the social networking service by the traffic monitoring service. The communication device comprises a means for receiving a short message sent by the social networking service, the short message containing traffic data and being sent by the social networking service in response to the traffic monitoring service submitting traffic data to the social networking service, a processor for parsing the short message and extracting the traffic data contained in the short message, and a routing module for processing the traffic data.

It is an advantage that the existing infrastructure of the social networking service can be used to efficiently and inexpensively deliver traffic status updates to users. Any communication device that is able to receive short messages from the social networking service can benefit from the present invention, including mobile phones that users carry with them while traveling.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a system for delivering traffic status updates through a social networking service according to the present invention.

FIG. 2 is a functional block diagram of the communication device according to the present invention.

FIG. 3 is a flowchart illustrating delivering traffic status updates according to the present invention method.

FIG. 4 shows the data groups available in a TMC protocol message and how they relate to the present invention.

FIG. 5 shows an example of an SMS message containing traffic data corresponding to multiple traffic events and adhering to the TMC protocol.

### DETAILED DESCRIPTION

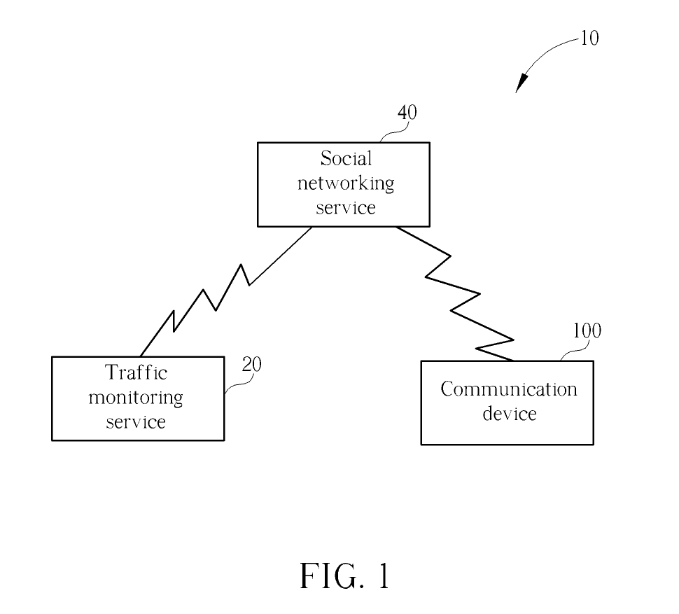

Please refer to FIG. 1. FIG. 1 is a block diagram of a system 10 for delivering traffic status updates through a social networking service 40 according to the present invention. A traffic monitoring service 20 monitors road and traffic conditions and submits traffic data to the social networking service 40. The social networking service 40 broadcasts short messages to users that have registered on the social networking service 40 as subscribers of the traffic monitoring service 20 and that have requested the social networking service 40 to send short messages to the users' devices. Subscribing devices, such as communication device 100, receive the broadcasted short message from the social networking service 40. The communication device 100 then parses the received short message in order to extract the traffic data from the short message. The traffic data can then be used to provide the user of the communication device 100 with updated traffic and road conditions. If the traffic data is in a format that is intelligible to users, the user can read the traffic data directly upon receiving the short message from the social networking service 40. Otherwise, if the traffic data is in sent in a coded format, such as using the TMC protocol, then software running on the communication device 100 can be used to process and display the received traffic status update.

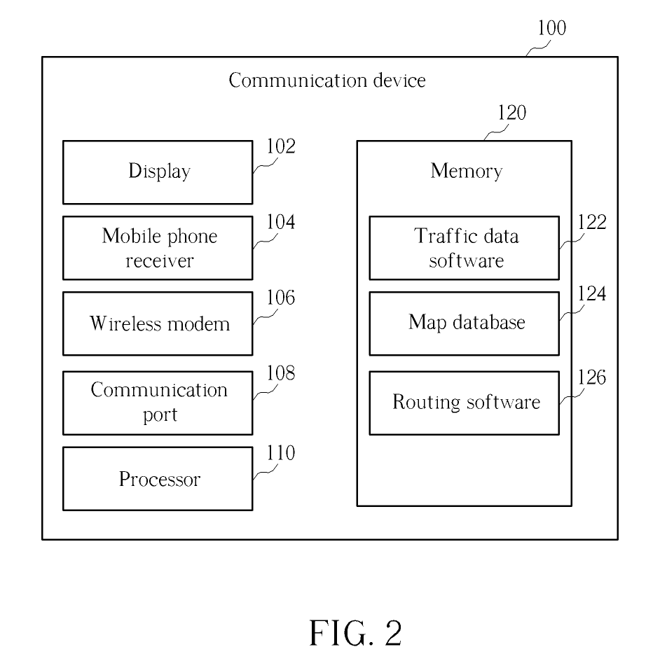

Please refer to FIG. 2. FIG. 2 is a functional block diagram of the communication device 100 according to the present invention. The communication device 100 contains a display 102 for displaying maps, navigational instructions, as well as traffic status update data. The communication device 100 also contains one or more of a mobile phone receiver 104, a wireless modem 106, and a communication port 108 for serving as a means for receiving short messages through the social networking service 40. The mobile phone receiver 104 may be a conventional receiver or transceiver included in a mobile phone for receiving data from a mobile phone subscriber network. The wireless modem 106 may be a General Packet Radio Service (GPRS) modem 16, a Bluetooth chip for enabling wireless communication with other electronic devices, or another kind of wireless modem for providing internet access to the communication device 100. The communication port 108 may be any data port, such as a Universal Serial Bus (USB) port, for allowing the communication device 100 to receive traffic status updates from an external source.

The communication device 100 also contains a processor for controlling operation of the communication device 100. A memory 120 is used for optionally storing received traffic data software 122, for storing a map database 124 containing map data, and for storing routing software 126.

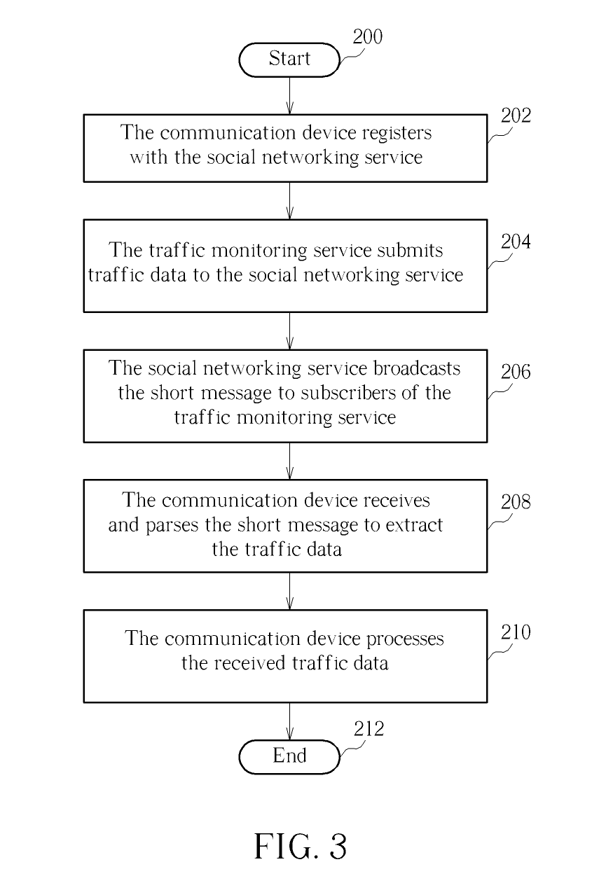

Please refer to FIG. 3. FIG. 3 is a flowchart illustrating delivering traffic status updates according to the present invention method. Steps contained in the flowchart will be explained below.

Step 200: Start.

Step 202: The communication device 100 registers with the social networking service 40 in order to receive traffic status updates from the traffic monitoring service 20. The communication device 100 subscribes to a feed of the traffic monitoring service 20 on the social networking service 40, and requests that the social networking service 40 sends short messages to the communication device 100 in response to traffic data being submitted to the social networking service 40 by the traffic monitoring service 20.

Step 204: When the traffic monitoring service 20 becomes aware of a traffic event, the traffic monitoring service 20 submits traffic data to the social networking service 40.

Step 206: The social networking service 40 broadcasts the short message to subscribers of the traffic monitoring service 20 that have requested the social networking service 40 to send short messages.

Step 208: The communication device 100 receives and parses the short message to extract the traffic data contained in the short message.

Step 210: The communication device 100 processes the received traffic data. The traffic data can be received and processed by the traffic data software 122, and the routing software 126 can suggest or alter navigation instructions based upon the received traffic data.

Step 212: End.

The communication device 100 may be any device having a means for receiving short messages from the social networking service 40 and informing the user about the traffic data contained in the short messages. The communication device 100 may be a personal digital assistant, a notebook computer, a personal navigation device, a mobile phone, or other such devices.

In one embodiment, the communication device 100 is a mobile phone and the social networking service 40 is Twitter™. In this case, the traffic monitoring service 20 establishes an account on Twitter™ and the user of the communication device 100 registers on the social networking service 40 as a subscriber, or “follower”, of the account belonging to the traffic monitoring service 20. The user of the communication device 100 also must change the user's account settings in order to request that the social networking service 40 send the short messages to the user's communication device 100. Upon having a traffic status update to send out, the traffic monitoring service 20 submits traffic data to the social networking service 40. The social networking service 40 then broadcasts a short message containing the traffic data to subscribers of the account belonging to the traffic monitoring service 20 that have requested the social networking service 40 to send short messages. One popular medium used by the Twitter™ service for sending out the short message is to use the Short Message Service (SMS) standard. Therefore, in this example, the social networking service 40 will encapsulate the traffic data in an SMS message before sending it out to subscribers who have requested SMS delivery. Since the communication device 100 in this example is a mobile phone, the communication device 100 can receive the SMS message from the social networking service 40 using the mobile phone receiver 104 of the communication device 100.

Once the communication device 100 has received the short message, the processor 110 will parse the short message and extract the traffic data. This traffic data can be used by the traffic data software 122 for updating traffic information on the communication device 100. The information contained in the traffic data can be displayed to the user of the communication device 100 on the display 102, and the routing software 126 can suggest or alter navigation instructions based upon the received traffic data.

The advantage of using a service like Twitter™ allows the traffic monitoring service 20 to send messages to multiple users without knowing who the users are in advance, and subscriptions to Twitter™ do not need to be actively managed by the traffic monitoring service 20. In addition, in many countries, users can receive incoming Twitter™ messages for free. Mobile phone users can receive traffic status updates via SMS messages, and the traffic data software 122 can monitor incoming SMS messages and can display traffic on the map contained in the map database 124. The routing software 126 can also change routing instructions according to the received traffic data.

When the user first installs the traffic data software 122 on the communication device 100, the traffic data software 122 will ask the user for their Twitter™ account details, and will ask the user which traffic feed should be followed. The user will select a traffic feed corresponding to the traffic monitoring service 20 in the user's geographical region. In this way, the user can receive SMS messages containing traffic data when local traffic events occur.

Currently, the Twitter™ service has a character limit of 140 characters per message, and the SMS standard has a character limit of 160 characters per message. The 20 character difference is reserved for overhead such as identifying the account name of the Twitter™ user. Even with the character limit of 140 characters per Twitter™ message, a great deal of traffic data can be contained in short messages.

The messages can be written in plain text that a user can read directly, such as “A traffic accident has occurred at the intersection of Main Street and 1^{st} Street”. However, to more efficiently send traffic data while using short messages, the RDS-TMC protocol format can be adhered to. The TMC protocol already provides a way of sending traffic data in small messages, and the standard is widely used.

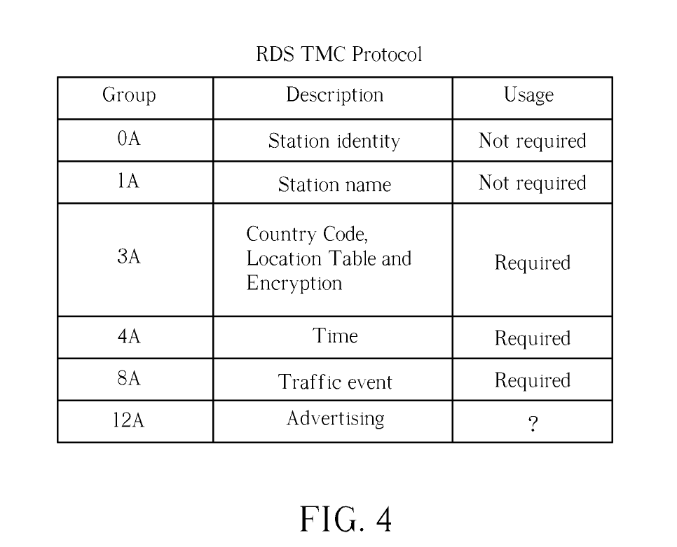

Please refer to FIG. 4. FIG. 4 shows the data groups available in a TMC protocol message and how they relate to the present invention. Not all of the available data groups, or data fields, in the standard TMC protocol are required for use in the present invention since messages are not limited to being sent over FM radio broadcasts. The first column in FIG. 4 represents the group names, or field names, in the TMC protocol message. The second column is a description of the group, and the third column indicates whether this group is required for use in the present invention. Group 0A indicates the station identity, and this group is not required since FM broadcasts are not used when sending traffic data via SMS message or via the internet, and there is therefore no station to identify. Group 1A indicates the station name, and this group is also not required for the same reasons as group 0A. Group 3A indicates the Country Code and Location Table, and encryption can be used to encrypt these values. Group 3A is required since the location of the traffic event is one of the key pieces of information for any traffic event. Group 4A indicates the time of the traffic event, and this field is required as well. Group 8A describes what the actual traffic event is, and this field is required as well. Group 12A is reserved for advertising data, and this field can be required or not, depending on the fee structure used by the related traffic monitoring service 20.

The traffic monitoring service 20 can either be subscribed to free of charge, or a subscription fee can be charged to followers of the traffic monitoring service 20 on the social networking service 40. If a fee is to be charged, then the traffic monitoring service 20 can use encryption in group 3A to encrypt the Country Code and Location Table, and only paying subscribers of the traffic monitoring service 20 will be given an encryption key for allowing them to decipher messages from the corresponding traffic monitoring service 20. The encryption key can be changed periodically in order to compel users to pay for the service in order to receive traffic status updates from the traffic monitoring service 20. If no subscription fee is charged, then advertising can be inserted into group 12A for offsetting the operating costs realized by the traffic monitoring service 20.

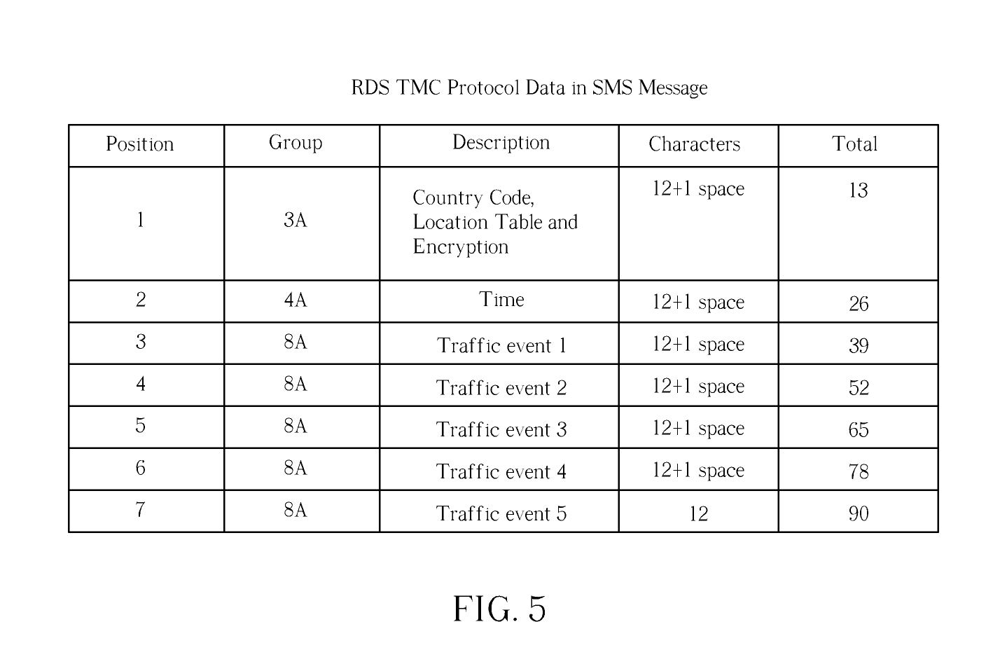

Please refer to FIG. 5. FIG. 5 shows an example of an SMS message containing traffic data corresponding to multiple traffic events and adhering to the TMC protocol. The first column in FIG. 5 indicates the position of the respective group in the SMS message, the second column indicates the group number, the third column indicates a description of the group's contents, the fourth column indicates the number of characters needed for the respective group, and the fifth column indicates a running total of the number of characters used in the SMS message. Only 12 characters are required for each group because no Program Identification (PI) code is needed for TMC data sent via SMS message. An additional character is required as a space between adjacent groups.

As shown in FIG. 5, in the first row, 13 characters are needed for indicating the Country Code, Location Table, and any encryption information. Another 13 characters are needed in the second row for indicating the time. Each traffic event requires only 12 characters, with an additional character being needed for a space between adjacent fields. Therefore, as shown in FIG. 5, five different traffic events can easily fit in a message having a character length of only 90 characters. Additional traffic events could also be included, so long as the total length does not exceed any limit, such as the 140-character limit imposed by Twitter™.

If more than one short message should be required for indicating traffic data at a certain time, then the social networking service can split the traffic data into multiple short messages and broadcast these multiple short messages to subscribers of the traffic monitoring service 20. The traffic data can either span the multiple short messages, or instead the traffic monitoring service 20 can choose to create short messages that are each independent and not tied to one another.

Please note that the present invention is not limited to using the TMC protocol for transmitting traffic data, and even if the TMC protocol is used, the composition of a short message containing traffic data does not have to follow the format or the order shown in FIG. 5. The format of the short message is open ended, and any traffic data sent over short message via a social networking service is permissible within the scope of the present invention.

Continuing in the example of a mobile phone receiving traffic status updates from Twitter™ via SMS message, the user may wish to alter the settings of the mobile phone in order to distinguish traffic status updates from other SMS messages received. For example, the user may wish to set mobile phone to turn off audible alerts when receiving an SMS message from Twitter™ or only when receiving a Twitter™ message from the traffic monitoring service 20. In addition, the user may set the mobile phone to automatically delete traffic data messages from the mobile phone's message inbox once they have been read and processed by the traffic data software 122. If the messages contain data in raw form, such as in the TMC protocol format, then the user will not be interested in reading raw data. In short, allowing the user to avoid extra distractions caused by receiving traffic status updates would make implementing the present invention on a mobile phone more convenient and enjoyable for the user.

In summary, the present invention takes advantage of the existing infrastructure of social networking services such as Twitter™ to efficiently deliver traffic status updates from a traffic monitoring service to users of a variety of communication devices. Mobile phones and any other communication devices that are able to receive short messages from a social networking service are able to receive traffic status updates using the present invention method and system. Benefits include simplifying the subscription process from the point of view of the traffic monitoring service 20, using the existing infrastructure of the social networking service 40, and reducing the cost needed for receiving traffic data over a mobile phone.

Those skilled in the art will readily observe that numerous modifications and alterations of the device and method may be made while retaining the teachings of the invention.

What is claimed is:

1. A method of receiving traffic status updates from a social networking service, the method comprising:
a communication device subscribing to a feed of a traffic monitoring service on a social networking service and requesting the social networking service to send short messages to the communication device when new traffic data is submitted to the social networking service by the traffic monitoring service;
the communication device receiving a short message containing traffic data from the social networking service in response to the traffic monitoring service submitting traffic data to the social networking service;
parsing the short message with the communication device and extracting the traffic data contained in the short message; and
processing the traffic data with a routing module of the communication device.

2. The method of claim 1, wherein the communication device is a mobile phone connecting to a mobile phone subscriber network for receiving short messages from the social networking service through the mobile phone subscriber network.

3. The method of claim 1, wherein the communication device comprises a wireless modem connecting to the internet for receiving messages through the social networking service.

4. The method of claim 1, wherein the short message has a length limit of 140 characters.

5. The method of claim 1, wherein the short message is contained within a Short Message Service (SMS) message.

6. The method of claim 1, wherein the short message conforms to the Radio Data System Traffic Message Channel (RDS-TMC) protocol format.

7. The method of claim 1, wherein when traffic data is too large to fit in a single short message, the method further comprising the social networking service broadcasting multiple short messages to subscribers of the traffic monitoring service that have requested the social networking service to send short messages, wherein the traffic data spans over multiple short messages.

8. The method of claim 1, wherein the short message is encrypted.

9. The method of claim 1, wherein when traffic data is too large to fit in a single short message, the method further comprising the traffic monitoring service submitting multiple short messages to the social networking service, wherein the traffic data spans over multiple short messages.

10. The method of claim 1, wherein the communication device is a mobile phone and the short message is contained within a Short Message Service (SMS) message received by the mobile phone.

11. A communication device for receiving traffic status updates from a social networking service, the communication device subscribing to a feed of a traffic monitoring service on the social networking service and requesting the social networking service to send short messages to the communication device when new traffic data is submitted to the social networking service by the traffic monitoring service, the communication device comprising:
a means for receiving a short message sent by the social networking service, the short message containing traffic data and being sent by the social networking service in response to the traffic monitoring service submitting traffic data to the social networking service;
a processor for parsing the short message and extracting the traffic data contained in the short message; and
a routing module for processing the traffic data.

12. The communication device of claim 11, wherein the means for receiving messages through the social networking service is a mobile phone connecting to a mobile phone subscriber network for receiving short messages from the social networking service through the mobile phone subscriber network.

13. The communication device of claim 11, wherein the means for receiving messages through the social networking service is a wireless modem connecting to the internet.

14. The communication device of claim 11, wherein the short message has a length limit of 140 characters.

15. The communication device of claim 11, wherein the short message is contained within a Short Message Service (SMS) message.

16. The communication device of claim 11, wherein the short message conforms to the Radio Data System Traffic Message Channel (RDS-TMC) protocol format.

17. The communication device of claim 11, wherein when traffic data is too large to fit in a single short message, the social networking service broadcasting multiple short messages to subscribers of the traffic monitoring service that have requested the social networking service to send short messages, the traffic data spanning over multiple short messages.

18. The communication device of claim 11, wherein the short message is encrypted.

19. The communication device of claim 11, wherein when traffic data is too large to fit in a single short message, the traffic monitoring service submits multiple short messages to the social networking service, the traffic data spanning over multiple short messages.

20. The communication device of claim 11, wherein the communication device is a mobile phone and the short message is contained within a Short Message Service (SMS) message received by the mobile phone.
